(19) United States
(12) Patent Application Publication
(10) Pub. No.: US 2009/0290606 A1
(43) Pub. Date: Nov. 26, 2009

(54) MODE-LOCKED EXTERNAL-CAVITY SURFACE-EMITTING SEMICONDUCTOR LASER

(76) Inventors: Juan L. Chilla, San Jose, CA (US); Bojan Resan, Mountain, CA (US); R. Russel Austin, Cool, CA (US)

Correspondence Address: Coherent, Inc. c/o Morrison & Forester, 425 Market Street, San Francisco, CA, 94105-2482, US

(21) Appl. No.: 12/126,577

(22) Filed: May 23, 2008

(51) Int. Cl. H01S 3/098; H01S 3/10; H01S 3/091

(52) U.S. Cl. 372/18; 372/75; 372/22

(57) ABSTRACT

A laser resonator includes an OPS gain-structure that is pumped with optical pulses repeatedly delivered at a pulse-repetition frequency corresponding to a resonant frequency of the laser resonator. The laser resonator additionally includes a passive mode-locking arrangement such that the resonator delivers mode-locked optical pulses. In one example the laser resonator further includes a CW optically pumped OPS gain-structure for increasing the power of the mode-locked pulses delivered from the resonator.

### TECHNICAL FIELD OF THE INVENTION

The present invention relates in general to semiconductor lasers. The invention relates in particular to optically pumped semiconductor lasers configured to deliver ultra short pulses of radiation.

### DISCUSSION OF BACKGROUND ART

Ultra short pulses of optical radiation from lasers configured to deliver such pulses are presently used in a variety of applications including microscopy, spectroscopy, laser surgery, and laser machining of inorganic materials. The term “ultra short” pulses as used here refers to pulses having a duration from about 100 picoseconds (ps) down to a few femtoseconds (fs).

One commonly used laser for providing ultra short pulses is a laser having a solid-state gain-medium such as titanium-doped sapphire (Ti:sapphire), forsterite, alexandrite, or chrysoberyl. Ti:sapphire is usually preferred. Such materials have a broad gain-bandwidth in a spectral range between about 700 nanometers (nm) and 1000 nm. Certain types of such laser are tunable over the gain-bandwidth.

These lasers must be optically pumped at wavelengths in the green region of the spectrum, and are usually pumped with frequency-doubled solid-state lasers having a neodymium-doped gain medium such as neodymium-doped YAG (Nd:YAG) or neodymium-doped yttrium orthovanadate (Nd:YVO₄) wherein radiation having a fundamental wavelength of about 1064 nm is converted to radiation having a wavelength of about 532 nm by frequency-doubling in one optically nonlinear crystal. Because of this, solid-state ultrafast lasers are relatively bulky and expensive. There is a need for a simpler laser for delivering ultra short pulses.

### SUMMARY OF THE INVENTION

The present invention is directed to a mode-locked external cavity surface emitting semiconductor laser. In one aspect, a laser in accordance with the present invention comprises a laser-resonator terminated by first and second mirrors and folded by a third mirror. The third mirror is surmounted by a multilayer semiconductor gain-structure including at least one quantum-well layer. An arrangement is provided for optically pumping the gain-structure with optical-pump pulses repeatedly delivered at a pulse-repetition frequency corresponding to a resonant frequency of the laser resonator. The resonator is arranged such that the resonator operates in mode-locked manner when the gain-structure is optically pumped with the optical-pump pulses.

In a preferred embodiment of the inventive laser, the optical pumping arrangement includes a diode-laser energized by a current alternating at the resonant frequency such that the diode-laser periodically delivers the optical-pump pulses at the resonant frequency. The optical-pump pulses are directed to the gain-structure for optically energizing the gain-structure.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 schematically illustrates one preferred embodiment of a mode-locked external-cavity surface-emitting semiconductor laser in accordance with the present invention having a thrice-folded laser-resonator including a optically-pumped, semiconductor (OPS) structure having a mirror-structure which provides one fold-mirror of the resonator, the OPS-structure having a gain-structure which is RF pulsed pumped by optical pulses from a diode-laser driven by a current supply modulated by an RF oscillator, and a Kerr-lens mode-locking arrangement being included in the laser resonator.

FIG. 2 schematically illustrates another preferred embodiment of a mode-locked external-cavity surface-emitting semiconductor laser in accordance with the present invention, similar to the laser of FIG. 1 but wherein the current supply is modulated by an RF amplifier actively locked by a detector and an RF filter to a resonant frequency of the resonator.

FIG. 3 schematically illustrates still another preferred embodiment of a mode-locked external-cavity surface-emitting semiconductor laser in accordance with the present invention, similar to the laser of FIG. 1 but wherein the laser-resonator is terminated at one end thereof by the mirror-structure of an additional OPS-structure that is continuously optically pumped.

FIG. 3A schematically illustrates a gain-structure suitable for being optically pumped with RF pulses as shown in the laser of FIG. 3.

FIG. 4 schematically illustrates still yet another preferred embodiment of a mode-locked external-cavity surface-emitting semiconductor laser in accordance with the present invention, similar to the laser of FIG. 1 but wherein the laser resonator is four times folded and includes an additional OPS-structure that is continuously optically pumped and with the mirror-structure of that additional OPS-structure functioning as a fold-mirror.

FIG. 5 schematically illustrates a further preferred embodiment of a mode-locked external-cavity surface-emitting semiconductor laser in accordance with the present invention, similar to the laser of FIG. 5 but wherein the KLM mode-locking arrangement is replaced by saturable semiconductor mirror.

FIG. 6 schematically illustrates an additional preferred embodiment of a mode-locked external-cavity surface-emitting semiconductor laser in accordance with the present invention, similar to the laser of FIG. 6 but wherein the mode-locking is provided by second-harmonic generation and reconversion of radiation with a portion of the second harmonic radiation not reconverted being delivered as output pulses.

### DETAILED DESCRIPTION OF THE INVENTION

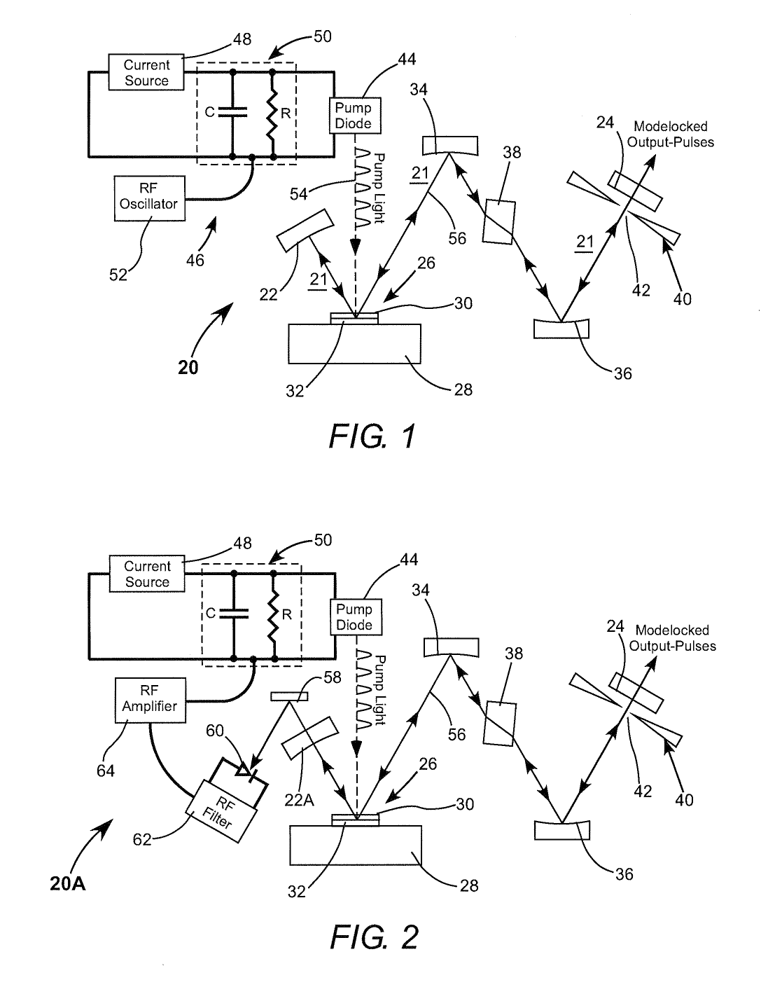

Referring now to the drawings, wherein like components are designated by like reference numerals, FIG. 1 schematically illustrates one preferred embodiment 20 of a mode-locked external-cavity surface-emitting semiconductor laser in accordance with the present invention. Laser 20 includes a laser-resonator 21 formed between mirrors 22 and 24. The resonator includes a multilayer, optically-pumped, semiconductor (OPS) structure (chip) 26 supported on a substrate or heat sink 28. OPS-structure 26 includes a multilayer gain-structure 30 including a plurality of quantum-well layers (not shown) spaced apart by spacer layers (not shown).

Gain-structure 30 surmounts a mirror-structure 32 which is arranged to be highly reflective at the fundamental wavelength. Mirror 22 is also highly reflective at this wavelength. Mirror 24 is partially reflective and partially transmissive at the fundamental wavelength and provides an outcoupling mirror of the resonator. It should be noted that only sufficient description of OPS-structure 26 is present here to describe principles of the present invention. A detailed description of the design and building of OPS-structures is present in U.S. Pat. No. 6,097,742, assigned to the assignee of the present invention.

Continuing with reference to FIG. 1, resonator 21 is thrice folded. Mirror-structure 30 provides one fold-mirror of the resonator with second and third folds provided by mirrors 34 and 36. Mirrors 34 and 36 are concave mirrors configured such that laser radiation propagating in the resonator forms a narrow beam waist between the mirrors. It should be noted here that the angle of incidence of radiation on the fold mirrors, in particular the angle of incidence on mirror-structure 30 is somewhat exaggerated in FIG. 1, and in other drawings herein, for convenience of illustration.

Located at the waist position between mirrors 34 and 36 is an element 38 of a material that exhibits a strong optical Kerr effect, for example sapphire (Al₂O₃). Locating element 38 at the beam waist position provides that the element is at a position where beam intensity is highest such that the highest Kerr effect will be obtained in the element. Located adjacent mirror is an aperture stop 40 having an aperture 42, such as a slit aperture, therein. Aperture 42 cooperative with element 38 encourages Kerr-lens mode-locked (KLM) operation of resonator 21.

Aperture 42 is configured such that the lasing mode of the resonator at the aperture is clipped and lasing is not possible in absence of a Kerr effect induced self focusing in element 38. When radiation intensity in the resonator becomes sufficient to provide such a self focusing in element 38, lasing is possible and energy is released from the resonator via mirror 24 as a pulse. Pulses are repeatedly released with a time therebetween equivalent to one round trip time in the resonator.

As noted above, the repetition frequency of the pump pulses matches a resonant frequency of the resonator which will also match the mode-locked repetition frequency. However, the length of the pump pulses will be longer than the length of the mode-locked output pulses as the mode locking mechanism will create shorter output pulses. It is believed that pulse repetition frequencies in the range of a few hundred megahertz to a few gigahertz are possible. The width of the mode-locked pulses can range from 100 picoseconds to 100 femtoseconds or less.

It should be noted here that only sufficient description of Kerr-lens mode-locking is presented here to describe principles of the present invention. A detailed description of Kerr-lens mode-locking is provided in U.S. Pat. No. 5,097,471, assigned to the assignee of the present invention, and the complete disclosure of which is hereby incorporated by reference. The '471 patent describes Kerr-lens mode-locking with a slit or “hard aperture” as described above with reference to laser 20. The '471 patent also describes Kerr-lens mode-locking in a so called “soft aperture” mode without a slit. Such soft-aperture Kerr lens mode-locking may be used in laser 20 and other embodiments of the present invention described hereinbelow, without departing from the spirit and scope of the present invention.

The KLM operation of laser 20 is self-started and reliably sustained by pulsed pumping (pulsed energizing) of gain-structure 30 of OPS-structure 26 at a pulse-repetition frequency (PRF) equal to a resonant frequency of the resonator. Pump-light pulses, here, are provided by a diode-laser 44 pumped by an RF-modulated current supply 46. Current supply 46 includes a current source 48 and an RF oscillator 52 tuned or tunable to the desired PRF the oscillator is connected in the current supply via an RC matching network 50. The current supplied to the diode-laser is sinusoidally modulated and is rectified by the diode-laser which accordingly emits a pump-light pulse at every other half-cycle of the modulated current. The pump-light pulses are incident on gain-structure 30 as indicated in FIG. 1 by dashed line. Laser-radiation pulses circulate in resonator 21 along the resonator axis indicated by solid line 56 and are delivered from resonator 21 via outcoupling mirror 24.

It should be noted, here, that it is important that mirror-structure 32 of OPS-structure 26 circulating radiation be used as a fold-mirror of the resonator such that circulating laser radiation is non-normally incident on gain-structure 30. Preferably this non-normal angle of incidence is between about 3° and 5° degrees. Preferably also, the OPS-structure is located in the resonator at a location which is not at an integer sub-multiple of the resonator length. This combined with the non-normal incidence maximizes the number of longitudinal modes that can circulate in the resonator which is important for optimum mode-locking.

It is further preferable that gain-structure 30 does not have the structure of an OPS gain-structure conventionally used in a CW OPS-laser. In a conventional OPS-structure for normal incidence CW operation the gain-structure typically has a plurality of spaced-apart quantum-well layers, with spacer layers therebetween having a thickness such that the quantum-well layers are optically spaced apart by one half-wavelength or some integer multiple thereof, at a peak gain wavelength of the gain-structure. This configuration provides a resonant structure at the lasing wavelength which introduces significant group delay dispersion in the structure. This has no effect in CW operation but could severely limit the shortness of pulses in mode-locked operation.

One preferable gain-structure for use in a laser in accordance with the present invention is a structure in which the spacing of the quantum-wells is selected to be a half-wavelength at a wavelength other than the lasing wavelength, and possibly even an anti-resonant structure. This would reduce group delay dispersion effects at the expense of a reduction in gain, i.e., a reduction in efficiency.

FIG. 2 schematically illustrates another preferred embodiment 20A of a mode-locked external-cavity surface-emitting semiconductor laser in accordance with the present invention. Laser 20A is similar to laser 20 of FIG. 1 with an exception that RF oscillator 52 of laser 20 is replaced in laser 20A by a photo-diode (detector) 60 connected to an RF filter 62, which is connected in turn to an RF amplifier 64. Further, maximally reflecting mirror 22 of laser 20 is replaced in laser 20A with a mirror which is highly reflecting at the fundamental wavelength but sufficiently transmissive to release a very small sample, for example less than about 0.5%, of circulating mode-locked radiation from the resonator. This radiation sample is directed by a mirror 58 to detector 60. RF filter 62 is tuned to pass one possible resonant (RF) frequency of the resonator formed between mirrors 22A and 24. This passed frequency is amplified by RF Amplifier 64 which uses the amplified frequency to modulate current to diode-laser 40 as described above.

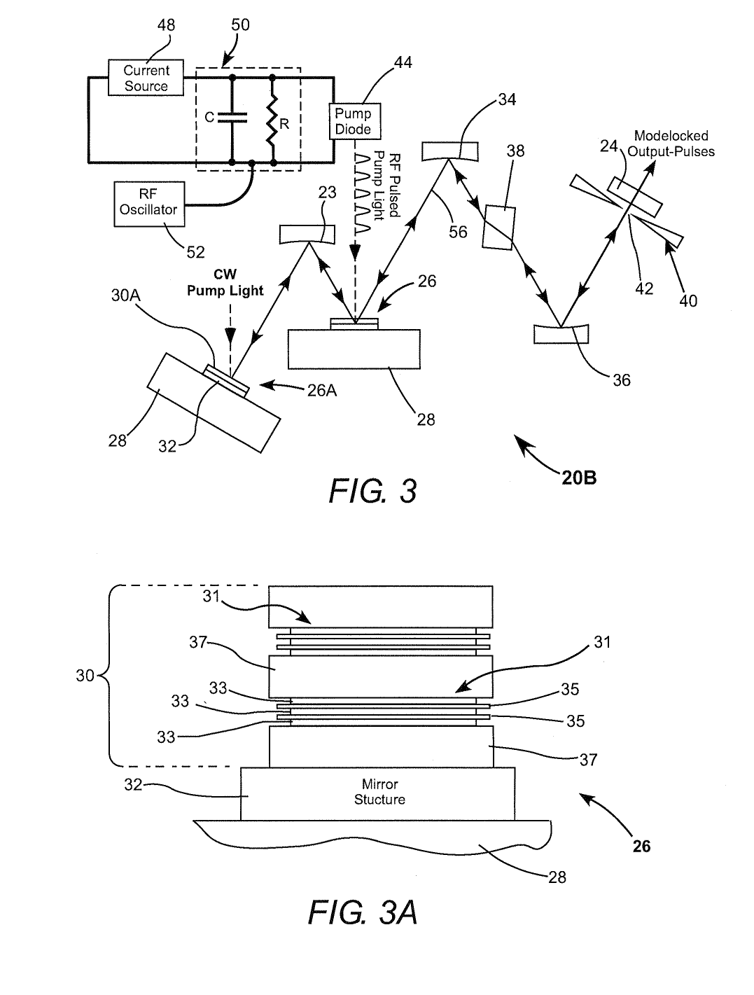

FIG. 3 schematically illustrates still another preferred embodiment 20B of a mode-locked external-cavity surface-emitting semiconductor laser in accordance with the present invention. Laser 20B is similar to laser 20 of FIG. 1 with an exception that the laser-resonator is terminated at one end thereof by a mirror-structure 32 of an additional OPS-structure 26A that is continuously optically pumped with light from a diode-laser or an array thereof (not explicitly shown). A fold-mirror 23 is located between structures 26 and 26A. Gain-structure 30A of structure 26A provides in effect an internal amplifier for mode-locked pulses circulating in and delivered from the laser resonator formed between mirror-structure 30 and mirror 24.

In structure 26A gain-structure 30A thereof is preferably is configured with about fifteen spaced apart quantum-well layers. It is also preferable however that the gain-structure not be a resonant structure at the lasing wavelength. Although gain-structure 30A is continuously pumped, laser 20C can still operate in a mode-locked manner to deliver a train of mode-locked pulses, if there is sufficient gain/loss difference in gain-structure 30. Gain, of course is provided when gain-structure 30 is receiving optical pump energy, and loss occurs (due to absorption in the structure) when the structure is not being pumped.

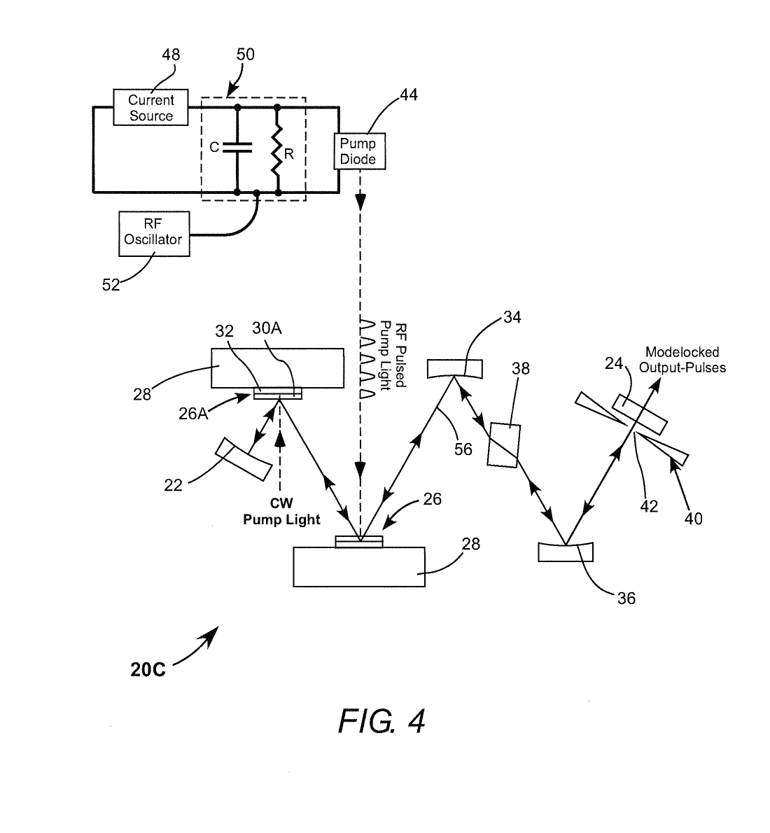

One preferred arrangement of gain-structure 30 for enhancing the gain/loss difference is schematically illustrated in FIG. 4A. Here gain-structure 30 of OPS-structure 26 includes superlattice structures 31 spaced apart by spacer layers 37. Each superlattice structure includes three quantum-well layers 33 separated by barrier layers 35 having a higher bandgap than that of the quantum-well-layers. The barrier layers preferably have a thickness less than about 10 nm. The quantum-well layers have the usual thickness, for example, about 150 nm. The spacer layer thickness cooperative with the thickness of the quantum-well layers and the barrier layers is preferably selected such that entire gain-structure is not a resonant structure at the lasing wavelength.

This arrangement of superlattices provides six quantum-well layers in a total thickness that would accommodate only two quantum-well layers in a typical OPS-laser gain-structure for CW operation. This means that the superlattice structure would have a greater gain/loss difference than an equivalent-thickness CW OPS gain-structure, even if it is not an efficient configuration for a resonator including only a single OPS-structure. An additional potential benefit of this superlattice structure is that, with barrier layers having the preferred thickness referred to above electrons can tunnel though the barriers from one quantum-well layer to an adjacent quantum-well layer. This can affect quantum levels in the layers in a way that effectively broadens the gain-spectrum of the gain-structure, making shorter pulses possible.

It should be noted, here, that the superlattice gain-structure described above is but one example of such a structure that is useful in embodiments of the present invention. Other such structures including a superlattice structure with less than or more than three barrier-separated quantum-well layers, or more or less than two spacer-separated superlattice structures may be used without departing from the spirit and scope of the present invention.

FIG. 4 schematically illustrates still yet another preferred embodiment 20C of a mode-locked external-cavity surface-emitting semiconductor laser in accordance with the present invention. Laser 20C is similar to laser 20 of FIG. 1 with an exception that the laser-resonator is additionally folded by a mirror-structure 32 of an additional OPS-structure 26A that is continuously optically pumped with light from a diode-laser or an array thereof (here again, not explicitly shown). The resonator is terminated by mirrors 22 and 24. Gain-structure 30A preferably has about fifteen spaced-apart quantum-well layers as described above with reference to laser 20B of FIG. 3.

In all embodiments of lasers in accordance with the present invention described above, pulsed energizing of a surface emitting semiconductor structure is combined with Kerr-lens mode-locking for delivering mode-locked pulses. This is because Kerr-lens mode-locking is a passive mode-locking scheme having a response time sufficiently fast that pulses having a duration of about a few hundred femtoseconds or less may be delivered by the inventive lasers. For applications where pulses having a longer duration are adequate, and relatively high-average power in a pulse train is required, internally amplified lasers in accordance with the present invention may use a passive mode-locking scheme other than Kerr-lens mode-locking. Pulses having a duration of about 10 ps or longer may be obtained without any passive mode-locking, i.e., by actively mode-locking alone via RF optical pulse pumping.

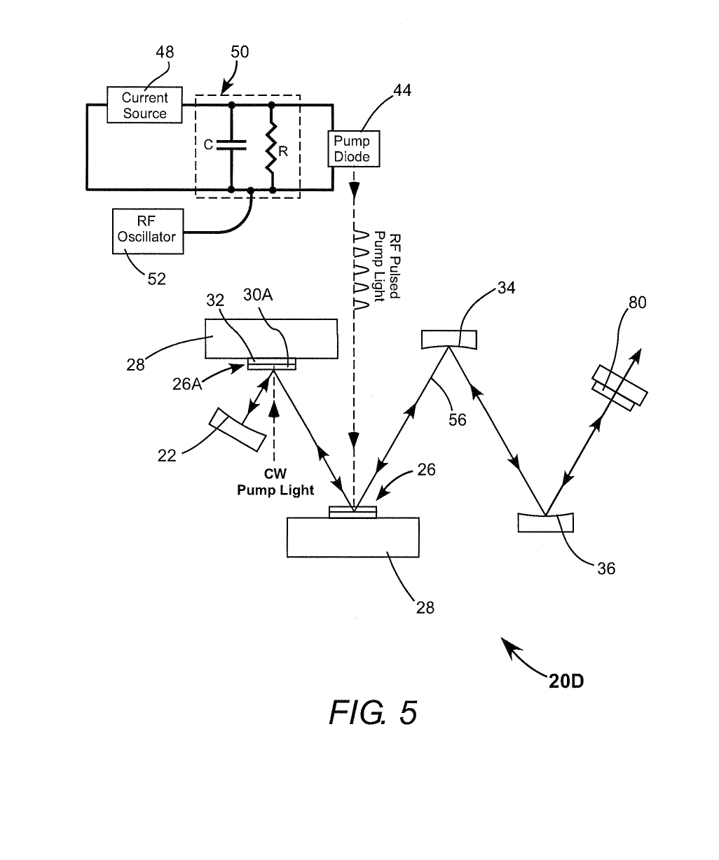

FIG. 5 schematically illustrates a further preferred embodiment 20D of a mode-locked external-cavity surface-emitting semiconductor laser in accordance with the present invention. Laser 20D is similar to laser 20C of FIG. 4 with an exception that the KLM mode-locking arrangement of laser 20D (element 38 and aperture stop 40) is replaced in laser 20D by terminating the resonator with a semiconductor saturable absorber mirror 80. While such a mirror has a much slower response than a KLM arrangement and is prone to unstable operation the laser still enjoys the benefit of the CW pumped internal amplifier structure 26A.

KLM may be substituted in internally amplified lasers in accordance with the present invention by other passive mode-locking schemes, for example a so called variable-reflectivity mirror described in U.S. Pat. No. 4,914,658 the complete disclosure of which is hereby incorporated by reference.

This variable reflectivity mode-locking mechanism of the '658 patent is based on combining a second-harmonic-generating (2HG) crystal spaced from a mirror such that second harmonic radiation generated from fundamental-wavelength radiation in a forward pass through the crystal is reflected from the mirror and reconverted to fundamental radiation in a reverse pass through the 2HG crystal. This technique is believed to be as fast as Kerr-lens mode-locking. A variation of this technique is described in U.S. Pat. No. 6,590,911, assigned to the assignee of the present invention, and the complete disclosure of which is hereby incorporated by reference. This variation provides that a portion of the second-harmonic radiation generated on the forward pass through the 2HG crystal is extracted from the mode-locked resonator as mode-locked 2H-pulses with a remaining, reverse-pass portion providing the mode-locking mechanism by reconversion.

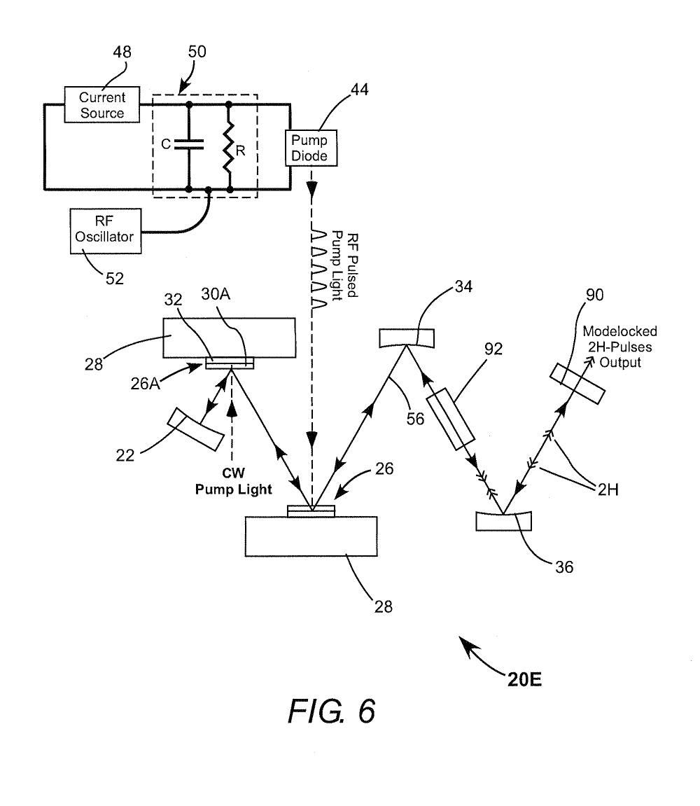

By way of example FIG. 6 schematically illustrates an additional preferred embodiment 20E of a mode-locked external-cavity surface-emitting semiconductor laser in accordance with the present invention. Laser 20E is similar to laser 20D of FIG. 5 with an exception that mode-locking is provided by second-harmonic generation from, and reconversion to, fundamental radiation. Second-harmonic radiation is generated and reconverted in an optically nonlinear crystal 92 located at the fundamental beam-waist position between mirrors 34 and 36.

The second-harmonic radiation is depicted by double open arrowheads 2H. Mirror 80 of laser 20E is replaced in laser 20F by a mirror 90 which is highly reflective to fundamental radiation and partially reflective and partially transmissive to 2H radiation. The mirror is preferably designed such that the relative phases of the reflected 2H and fundamental radiations optimize reconversion of the 2H-radiation to fundamental radiation in crystal 92. The design of such a mirror is discussed in the above-referenced '911 patent. As an alternative, mirror 90 could be made highly reflective of the 2H radiation and partially transmissive to the fundamental radiation. It is believed that this mode-locking technique with an output of fundamental radiation instead of 2H-radiation may be substituted for Kerr-lens mode-locking in any of the above described embodiments of the inventive laser.

In summary, the present invention is described above in terms of a preferred and other embodiments. The invention is not limited, however, to the embodiments described and depicted. Rather, the invention is limited only by the claims appended hereto.

What is claimed is:

1. A laser comprising:
a laser-resonator terminated by first and second mirrors and folded by a third mirror, the third mirror being surmounted by a first multilayer semiconductor gain-structure including at least one quantum-well layer;
an arrangement for optically pumping the gain-structure with optical-pump pulses repeatedly delivered at a pulse-repetition frequency corresponding to a resonant frequency of the laser resonator; and
wherein the resonator is arranged such that the resonator operates in mode-locked manner when the gain-structure is optically pumped with the optical-pump pulses.

2. The laser of claim 1, wherein the optical pumping arrangement includes a diode-laser energized by an alternating current at the resonant frequency such that the diode-laser periodically emits the optical-pump pulses at the resonant frequency, the optical-pump pulses being directed to the gain-structure for optically pumping the gain-structure.

3. The laser of claim 1, wherein the resonator arrangement for mode-locked operation is a Kerr-lens mode-locking arrangement.

4. The laser of claim 3, wherein resonator is additionally folded by fourth and fifth mirrors located between the third mirror and the second mirror an having a concave radius of curvature and arranged such that there is a beam-waist location therebetween for radiation circulating in the resonator and wherein the Kerr-lens mode-locking arrangement includes a transmissive optical element located in the resonator at the beam-waist location between the fourth and fifth layers.

5. The laser of claim 4, wherein the Kerr-lens mode-locking arrangement further includes an aperture stop located in the laser resonator between the fifth mirror and the second mirror.

6. The laser of claim 1, wherein the resonator is arranged to deliver mode-locked output optical pulses via the second mirror thereof, the mode-locked output optical pulses having a fundamental wavelength characteristic of the gain-structure.

7. The laser of claim 1, wherein the resonator arrangement for mode-locked operation includes an optically nonlinear crystal arranged cooperative with the second mirror for second-harmonic generation and reconversion, the second-harmonic generation and reconversion providing passive mode-locking of the resonator.

8. The laser of claim 7, wherein the optically nonlinear crystal arrangement cooperative with the second mirror is such that the resonator delivers mode-locked output optical pulses having the second-harmonic wavelength of a fundamental wavelength characteristic of the gain-structure.

9. The laser of claim 1, wherein the laser resonator further includes a second multilayer semiconductor gain-structure surmounting the first mirror, and there is an arrangement for optically pumping the second gain-structure with continuous wave (CW) optical-pump radiation.

10. The laser of claim 1, wherein the laser resonator is additionally folded by a fourth mirror located between the first and third mirrors, wherein the fourth mirror is surmounted by a second multilayer semiconductor gain-structure, and wherein there is an arrangement for optically pumping the second gain-structure with continuous wave (CW) optical-pump radiation.

11. The laser of claim 1, wherein the optical pumping arrangement includes a diode-laser energized by a current source modulated at the resonant frequency thereby providing alternating current to the diode-laser at the resonant frequency such that the diode-laser periodically emits the optical-pump pulses at the resonant frequency, the optical-pump pulses being directed to the gain-structure for optically pumping the gain-structure.

12. The laser of claim 11, wherein the current source is modulated by an oscillator tuned to the resonant frequency.

13. The laser of claim 11, further including a detector arrangement arranged to sample output of the resonator and provide therefrom an electrical signal representative of the resonant frequency of the resonator, and an amplifier for amplifying the resonant frequency signal, and wherein the current source is modulated by the amplified resonant frequency signal.

14. A laser comprising:
a laser-resonator terminated by first and second mirrors including first and second multilayer semiconductor gain-structures each thereof including at least one quantum-well layer, the laser resonator being folded by a third mirror with the first gain-structure surmounting the third mirror;
the first gain-structure arranged to be optically pumped with optical-pump pulses repeatedly delivered at a pulse-repetition frequency corresponding to a resonant frequency of the laser resonator;
the second gain-structure arranged to be optically pumped with CW optical radiation; and
the resonator being arranged such that the resonator operates in mode-locked manner when the gain-structures are optically pumped and delivers output optical pulses at the resonant frequency.

15. The laser of claim 14, wherein the second gain-structure surmounts the first mirror.

16. The laser of claim 15, wherein the resonator delivers the output optical pulses via the second mirror.

17. The laser of claim 14, wherein the resonator is additionally folded by a fourth mirror and the second gain-structure surmounts the fourth mirror.

18. A laser comprising:
a laser-resonator terminated by first and second mirrors and folded by a third mirror, the third mirror being surmounted by a first multilayer semiconductor gain-structure including at least one quantum-well layer;
an arrangement for optically pumping the gain-structure with optical-pump pulses repeatedly delivered at a pulse-repetition frequency corresponding to a resonant frequency of the laser resonator; and
an arrangement for passively mode-locking the resonator such that the resonator delivers mode-locked pulses at the resonant frequency.

19. The laser of claim 18, wherein the passive mode-locking arrangement is a Kerr-lens mode-locking arrangement.

20. The laser of claim 18, wherein the arrangement for passively mode-locking the resonator includes an optically nonlinear crystal arranged cooperative with the second mirror for second-harmonic generation and reconversion, the second-harmonic generation and reconversion providing passive mode-locking of the resonator.
